(19) United States
(12) Patent Application Publication
(10) Pub. No.: US 2009/0012325 A1
(43) Pub. Date: Jan. 8, 2009

(54) Methods for preparing phosphoric acids of combrestastatin and derivatives thereof

(76) Inventors: Ajith Manage, Longoworth (GB); Richard Hallewell, Didcot (GB); Amanda Stewart, Abdingdon (GB)

Correspondence Address: LAHIVE & COCKFIELD, LLP;FLOOR 30, SUITE 3000, ONE POST OFFICE SQUARE, BOSTON, MA, 02109, US

(21) Appl. No.: 12/070,899

(22) Filed: Feb. 21, 2008

Related U.S. Application Data
(60) Provisional application No. 60/902,995, filed on Feb. 22, 2007.

(51) Int. Cl. C07F 9/06

(52) U.S. Cl. 562/23

(57) ABSTRACT

Methods of synthesizing phosphoric acid of combretastatin A-4, phosphoric acid of combretastatin A-4 derivatives, and trans-isomers thereof are disclosed.

### RELATED APPLICATIONS

This application claims priority to U.S. Provisional Application Ser. No. 60/902,995, entitled “Methods for Preparing Phosphoric Acids of Combretastatin and Derivatives Thereof,” filed on Feb. 22, 2007. The entire contents of the aforementioned application are hereby incorporated herein by reference.

### BACKGROUND OF THE INVENTION

The present invention relates generally to the field of compounds that can be useful in the treatment of one or more neoplastic diseases.

In particular, the present invention relates to new and efficient methods of synthesizing prodrugs of the compound denominated Combretastatin A-4 (CA-4) described, in U.S. Pat. No. 4,996,237.

Combretastatin A-4 (CA-4, Formula 1 below) is reported to be an antineoplastic compound inhibiting cancer cell growth and tubulin assembly.

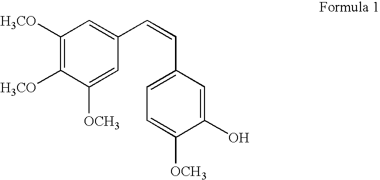

Water-soluble prodrug derivatives of combretastatin A-4 have been reported. In particular, synthesis of phosphate salts of combretastatin A-4, designated “Combretastatin A-4 P” (CA4P) (Formula 2 below) have been found to impart the requisite water solubility to the prodrug and are disclosed in U.S. Pat. Nos. 5,561,122; 6,670,344; 6,855,702; and 7,078,552.

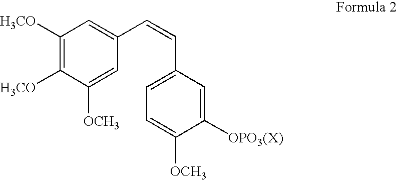

where X=H(Z) (monovalent) or X=Z (divalent), wherein Z is a pharmaceutically acceptable salt, e.g., alkali metal (Na⁺, Li⁺), an alkali earth metal (e.g., Mg²⁺, Mn²⁺, Ca²⁺, Cs²⁺), a transition metal (e.g., Zn²⁺), a heteroarylene, a heterocyclyl, a nucleoside, a nucleotide, an alkaloid, an amino-sugar, an amino-nitrile, or a nitrogen-containing antibiotic, an organic amine, or an amino acid. The phosphate group of the prodrug combretastatin A-4P reportedly is hydrolyzed in vivo to liberate the active drug combretastatin A-4. However, the currently available methods for synthesizing combretastatin A-4P are not easily scalable and suffer for sub-optimal yields.

Accordingly, new synthesis methods to produce phosphoric acids of combretastatin, derivatives thereof (e.g., phosphate salts) and isomers thereof are needed.

### SUMMARY OF THE INVENTION

It is an object of the present invention to synthesize phosphoric acids of combretastatin, derivatives thereof and isomers thereof.

In one aspect, the invention provides a method of synthesizing a phosphoric acid of combretastatin A-4, phosphoric acid of combretastatin A-4 derivatives, and trans-isomers thereof comprising:

reacting a combretastatin A-4 or a combretastatin A-4 derivative having the following chemical structure:

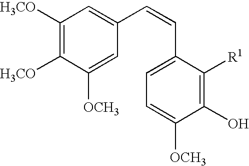

wherein R¹ is H or OH,

with POCl₃ and a base in the presence of a solvent to form said phosphoric acid of combretastatin A-4 or combretastatin A-4 derivative.

In one embodiment, the base to be used in the reaction is an amine. In another embodiment, the amine is Et₃N. In another embodiment, the solvent to be used in the reaction is a halogenated solvent. In still another embodiment, the solvent is dichlromethane (DCM). In other embodiments, the solvent to be used in the reaction is an ether. In an exemplary embodiment, the solvent of the reaction is tetrahydrofuran (THF).

In one embodiment, the intermediate phosphodichloridate resulting from the reaction is hydrolyzed to form said phosphoric acid of combretastatin A-4 or combretastatin A-4 derivative. In another embodiment, the intermediate phosphodichloridate is hydrolyzed with water, acetone, KOH, Na₂CO₃, ethyl acetate, or any combination thereof.

In another embodiment of the reaction of the invention, POCl₃ is first added to the solvent of the reaction, followed by addition of the base and combretastatin A-4 or a combretastatin A-4 derivative. In another embodiment, the reaction components are added to the reaction mixture at temperatures between 0-25° C. In still another embodiment, the reaction components are added to the reaction mixture at temperatures between 0-5° C. In yet another embodiment, the reaction components are added together at −35 to −45° C.

In one embodiment of the above formula, R¹ is H. In another embodiment of the above formula, R¹ is OH.

In another aspect, the invention provides a method of synthesizing a compound of the following formula:

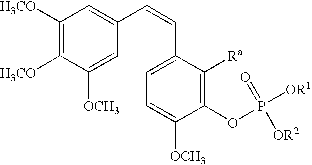

wherein R^{a} is H or OP(O)(OR³)OR⁴; and

OR¹, OR², OR³ and OR⁴ are each, independently, OH or —O⁻QH⁺ or —O⁻M⁺, wherein M⁺ is a monovalent or divalent metal cation, and Q is, independently:

a) an amino acid containing at least two nitrogen atoms where one of the nitrogen atoms, together with a proton, forms a quaternary ammonium cation QH⁺; or

b) an organic amine containing at least one nitrogen atom which, together with a proton, forms a quaternary ammonium cation, QH⁺;

comprising

reacting a combretastatin A-4 or a combretastatin A-4 derivative having the following chemical structure:

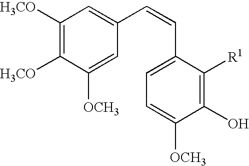

wherein R¹ is H or OH,

with POCl₃ and a base in the presence of a solvent to form said a phosphoric acid of combretastatin A-4 or combretastatin A-4 derivative; and, optionally,

reacting the phosphoric acid with an appropriate amine or metal cation to form said pharmaceutically acceptable salt of combretastatin A-4 or combretastatin A-4 derivative.

In one embodiment of the reaction that forms the phosphoric acid derivative of combretastatin A-4, or the salt thereof, the product is subsequently upgraded with water, acid, IPA, or any combination thereof.

In another embodiment of the reaction, the amine is tromethamine (“TRIS”), histidine, ethanolamine, diethanolamine, ethylenediamine, diethylamine, triethanolamine, glucamine, N-methylglucamine, ethylenediamine, 2-(4-imidazolyl)-ethylamine, choline, or hydrabamine. In a preferred embodiment, the amine is TRIS.

In another embodiment, the metal cation is Li, K, Na, Ca, Cs, Mg, Mn, Zn or Ca. In a preferred embodiment, R^{a} is H. In another preferred embodiment, R^{a} is OH.

Further features and advantages of the invention will be apparent from the detailed description hereinafter set forth, together with the accompanying drawings.

### BRIEF DESCRIPTION OF THE DRAWINGS

FIG. 1 is an ¹H NMR spectra of a phosphoric acid-product prepared using the methods of the invention

### DETAILED DESCRIPTION OF THE INVENTION

The elucidation and isolation of Combretastatin A-4 are described in U.S. Pat. No. 4,996,237, while early efforts to develop a Combretastatin A-4 prodrug are described in U.S. Pat. No. 5,561,122. The general background information from each of those patents is incorporated herein by reference. The subject invention presents a novel method of synthesizing Combretastatin A-4 prodrugs (e.g., Combretastatin A-4 phosphate prodrugs), derivatives thereof, precursors thereof, and isomers thereof.

The difficulties with existing phosphorylation methods in the synthesis of combretastatin A-4P were investigated and a novel and efficient synthesis of prodrugs of combretastatin A-4 were developed that substantially reduced the cost and time required to synthesize combretastatin A-4P.

An example of a known synthesis for combretastatin A-4P and prodrugs thereof is shown below (Scheme I). A similar synthesis procedure is described in U.S. Pat. No. 6,743,937, which is incorporated herein by reference in its entirety. This synthesis is suboptimal as requires the use of protected phosphorylation agent which require subsequent deprotection steps that can increase the time and cost of isolating the combretastatin A-4 prodrugs and its intermediates by this method, as well as limiting the optimal yield. Moreover, synthesis of other more desirable and stable salts (e.g., TRIS) require additional synthesis steps. For example, the product of Scheme I (IV) must be further processed to produce the corresponding phosphoric acid V (CA4), which can be used to prepare more pharmaceutically acceptable salt, such as the TRIS salt VI (Scheme II).

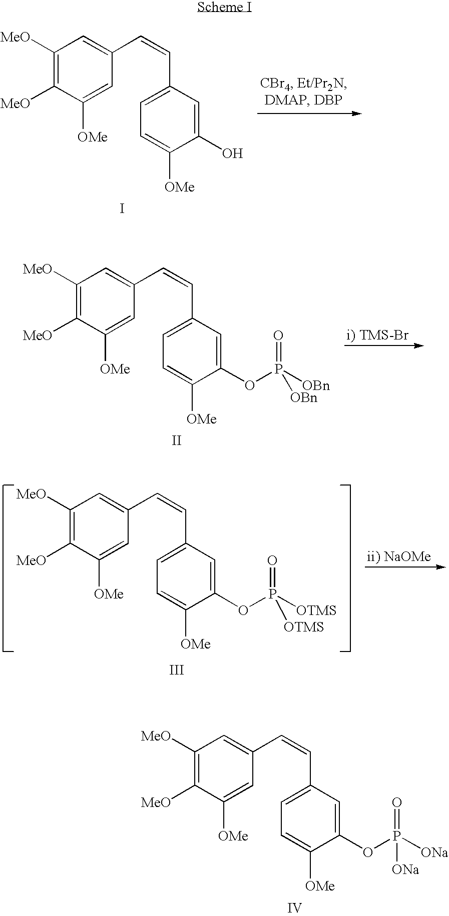

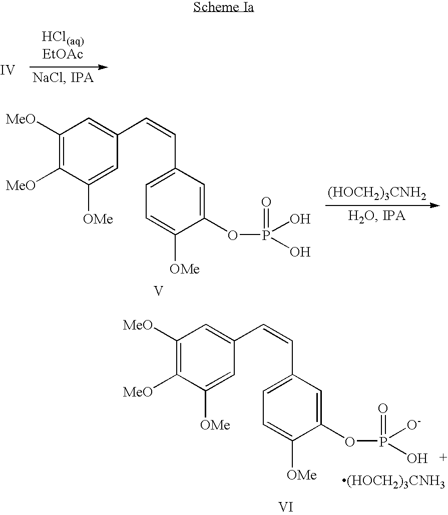

### Synthesis Methods of the Invention

In one aspect, the present invention involves the synthesis of a phosphoric acid derivative of combretastatin A4, and derivatives thereof, using POCl₃. This procedure minimizes the amount of steps required for the production of such compounds, resulting in increased overall yields of combretastatin A4 prodrugs or derivatives thereof. For example, using the methods of the invention, various steps of the Scheme I procedure shown above can be eliminated as follows (Scheme II):

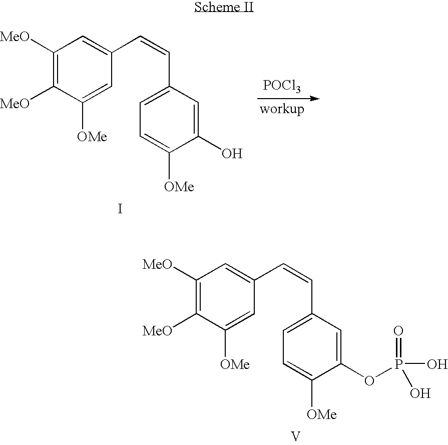

Generally speaking, this method can be applied to all combretastatin derivatives, including those of the Formula A:

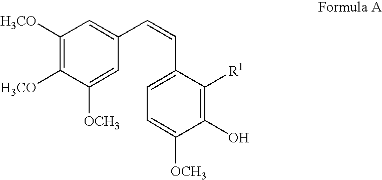

wherein R¹ is H or OH. In a particular embodiment, R¹ is H. In another embodiment, R¹ is OH.

In one embodiment, the compound of Formula A is converted to the corresponding phosphoric acid in the presence of POCl₃, a base and a solvent. The term “base,” as used herein, means a Bronsted-Lowry base. A Bronsted-Lowry base is a reagent that is capable of accepting a proton (H⁺) from an acid present in a reaction mixture. Examples of Bronsted-Lowry bases include, but are not limited to, inorganic bases such as sodium carbonate, sodium bicarbonate, sodium hydroxide, potassium carbonate, potassium bicarbonate, potassium hydroxide, and cesium carbonate, organic bases such as triethylamine, diisopropylethylamine, diisopropylamine, dicyclohexylamine, morpholine, pyrrolidone, piperidine, pyridine, 4-N,N-dimethylaminopyridine (DMAP), and imidazole.

In a preferred embodiment, the base is an amine. The term “amine” should be understood as being broadly applied to both a molecule, or a moiety or functional group, as generally understood in the art, and can be primary, secondary, or tertiary. The term “amine” includes compounds where a nitrogen atom is covalently bonded to at least one carbon, hydrogen or heteroatom. The terms include, for example, but are not limited to, “alkyl amino,” “arylamino,” “diarylamino,” “alkylarylamino,” “alkylaminoaryl,” “arylaminoalkyl,” “alkaminoalkyl,” “amide,” “amido,” and “aminocarbonyl.” The term “alkyl amino” comprises groups and compounds wherein the nitrogen is bound to at least one additional alkyl group. The term “dialkyl amino” includes groups wherein the nitrogen atom is bound to at least two additional alkyl groups. The term “arylamino” and “diarylamino” include groups wherein the nitrogen is bound to at least one or two aryl groups, respectively. The term “alkylarylamino,” “alkylaminoaryl” or “arylaminoalkyl” refers to an amino group which is bound to at least one alkyl group and at least one aryl group. The term “alkaminoalkyl” refers to an alkyl, alkenyl, or alkynyl group bound to a nitrogen atom which is also bound to an alkyl group.

In a particular embodiment, the base is triethylamine.

The term “solvent,” as used herein, refers to a solvent that is inert to the ongoing reaction and sufficiently solubilizes the reactants to effect the desired reaction. Examples of suitable solvents include, but are not limited to, halogenated solvents, including, but not limited to, dichloromethane, chloroform, carbon tetrachloride, 1,2-dichloroethane, mixtures thereof, and the like. In a particular embodiment, the solvent is dichloromethane (DCM). Other examples of suitable solvents include ethers, such as diethyl ether, tetrahydrofuran (THF), and the like. In one exemplary embodiment, the solvent is tetrahydrofuran (THF).

The term “prodrug,” as used herein, refers to compounds which transform rapidly in vivo to another compound, for example, by hydrolysis. Prodrugs of the invention also can be active in the prodrug form. For example, prodrug froms of comretastatin A4, are, fore example, the phosphoric acid deriviative and salts of the phosphoric acid derivative, e.g., the TRIS salt. A thorough discussion is provided in Higuchi et al., Prodrugs as Novel Delivery Systems, Vol. 14, of the A.C.S.D. Symposium Series, and in Roche (ed.), Bioreversible Carriers in Drug Design, American Pharmaceutical Association and Pergamon Press, 1987.

Once the corresponding phosphoric acid is synthesized using POCl₃, the phosphoric acid can then be used in further reactions to synthesize various phosphoric acid salts and esters. “Salt” is a pharmaceutically acceptable salt and can include acid addition salts such as the hydrochlorides, hydrobromides, phosphates, sulphates, hydrogen sulphates, alkylsulphonates, arylsulphonates, acetates, benzoates, citrates, maleates, fumarates, succinates, lactates, and tartrates; alkali metal cations such as Na, K, Li; alkali earth metal salts such as Mg or Ca; or organic amine salts such as those disclosed in PCT International Application Nos. WO02/22626 or WO00/48606 and U.S. Pat. Nos. 6,855,702 and 6,670,344, which are incorporated herein by reference in their entireties. Exemplary organic amine salts are tromethamine (TRIS) salts and amino acid salts (e.g. histidine salts) of the compounds of the invention. Other exemplary salts which can be synthesized using the methods of the invention include those described in U.S. Pat. No. 7,018,987, which is incorporated by reference herein.

In one embodiment, the corresponding phosphoric acid is synthesized using POCl₃, and then used in further reactions to synthesize various phosphoric acid salts and esters such as those of Formula B:

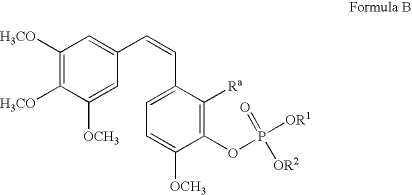

and pharmaceutically acceptable salts thereof;

wherein R^{a} is H or OP(O)(OR³)OR⁴; and

OR¹, OR², OR³ and OR⁴ are each, independently, OH or —O⁻QH⁺ or —O⁻M⁺, wherein M⁺ is a monovalent or divalent metal cation, and Q is, independently:

a) an amino acid containing at least two nitrogen atoms where one of the nitrogen atoms, together with a proton, forms a quaternary ammonium cation QH⁺; or

b) an organic amine containing at least one nitrogen atom which, together with a proton, forms a quaternary ammonium cation.

In one embodiment of Formula B, R^{a} is H, one of OR¹ and OR² is hydroxyl, and the other is —O⁻QH⁺ where Q is L-histidine. In another embodiment of Formula II, R^{a} is H, one of OR¹ and OR² is hydroxyl and the other is —O⁻QH⁺ and Q is tris(hydroxymethyl)amino methane (“TRIS”).

In another embodiment of Formula B, R^{a} is H or OP(O)(OR³)OR⁴, and R¹, R², R³ and R⁴ are each, independently, an aliphatic organic amine, alkali metal, transition metal, heteroarylene, heterocyclyl, nucleoside, nucleotide, alkaloid, amino sugar, amino nitrile, or nitrogenous antibiotic.

In another embodiment of Formula B, R¹, R², R³ and R⁴ are each, independently, Na, TRIS, histidine, ethanolamine, diethanolamine, ethylenediamine, diethylamine, triethanolamine, glucamine, N-methylglucamine, ethylenediamine, 2-(4-imidazolyl)-ethylamine, choline, or hydrabamine.

In one embodiment of the phosphorous oxychloride reaction of the invention, POC₃ is first added to the solvent of the reaction, followed by addition of the base and CA4 or CA4 derivative. In one embodiment, these components are added to the reaction mixture at temperatures between 0-25° C., preferably 0-10° C., preferably 0-5° C. In another embodiment, the reaction mixture is stirred for 1 minute to 48 hours before work-up, preferably 10 minutes to 24 hours, preferably 15 minutes to 2 hours, preferably 20 to 60 minutes before workup. In another embodiment, the reaction is performed at −35 to −45° C. (e.g., in the solvent tetrahydrofuran (THF)) and the reaction mixture is stirred for 1-2 hours before workup.

As used herein, the term “workup” is defined as the sequence of steps performed on a reaction mixture to obtain the reaction product in crude form prior to purification. A general workup procedure can involve quenching the reaction mixture; diluting the reaction mixture with a water insoluble organic solvent; adding an aqueous phase to wash the organic phase; separating, drying, and concentrating the organic phase to a crude residue. Concentration of the organic phase comprises removal of volatiles such as solvents. Concentration is usually effected under vacuum (about 5 mmHg to about 100 mmHg), e.g., on a roto-evaporation apparatus. The crude residue comprises the desired compound and any other by-products.

As used herein, the term “quenching” means deactivating the reaction mixture's active components after the reaction is complete. Typically, quenching a reaction mixture involves adding water, an aqueous buffer, an aqueous acid, or an aqueous base at about room temperature to about 0° C. and agitating the mixture. Quenching procedures are well known to those of ordinary skill in the art and readily selected according to the reaction.

In a particular embodiment, the reaction mixture of the invention is worked-up with water, acetone, KOH, Na₂CO₃, ethyl acetate, or any combination thereof. In another embodiment, the reaction is worked-up to convert the intermediate phosphodichloridate to the corresponding phosphoric acid, e.g., according to the following scheme:

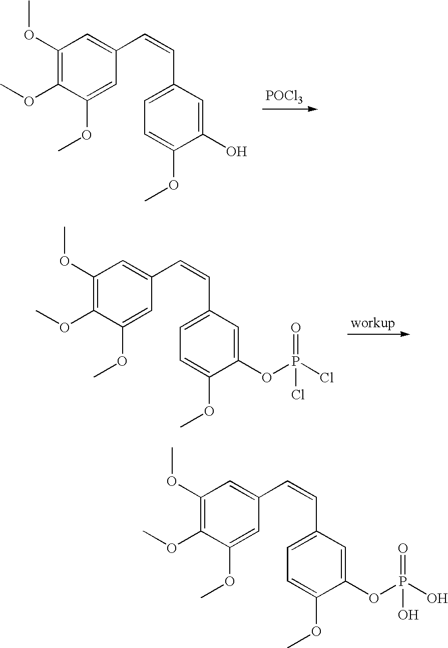

The end products of the reactions described herein can be isolated by conventional techniques, e.g. by extraction, crystallization, distillation, chromatography, etc. In one embodiment, any of the products of the reactions described herein can be processed through an additional upgrading step to remove unwanted impurities, including, e.g., an undesired trans form of the combretastain derivative (e.g., CA4P or CA4P-TRIS). The upgrading step can be performed in a number of different solvents, such as water and/or an alcohol (e.g., MeOH, EtOH, or IPA), followed by heating (20° C.-140° C., preferably 30° C.-100° C., preferably 35° C.-50° C.), for 10 minutes to 24 hours, preferably 15 minutes to 2 hours, preferably 60 minutes to 1.5 hours, and then followed by an isolation technique, such as filtering.

### EQUIVALENTS

Those skilled in the art will recognize, or be able to ascertain using no more than routine experimentation, many equivalents to the specific embodiments of the invention described herein. Such equivalents are intended to be encompassed by the following claims.

### INCORPORATION BY REFERENCE

The entire contents of all patents, published patent applications and other references cited herein are hereby expressly incorporated herein in their entireties by reference.

### EXAMPLES

The invention is further illustrated by the following examples, which should not be construed as further limiting.

### Use of Phosphorous Oxychloride

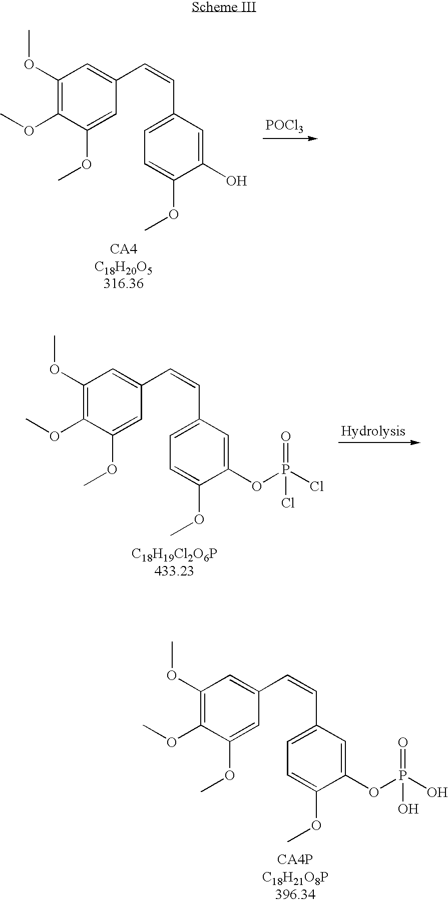

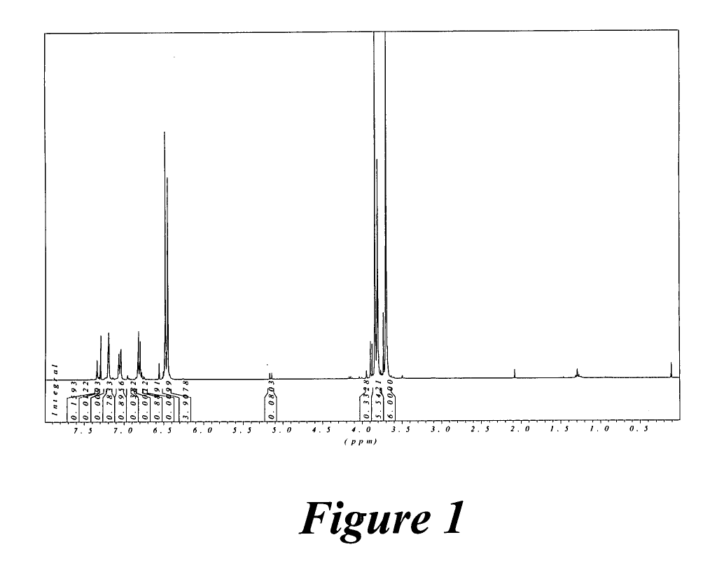

In the first instance, the method of McGuigan et al. (J. Med. Chem., 1993, 36, 1048-1052) was adapted. The starting material is insoluble in Et₂O and 5 volumes of MeCN had to be charged. Following addition of a solution of the starting material and Et₃N in Et₂O/MeCN to POCl₃ in Et₂O at 0 to 5° C. under nitrogen, the mixture was stirred 16 to 20 hours at 15 to 25° C. During this time, a white solid formed in suspension and was later found to be Et₃N.HCl. IPC by HPLC indicated 82% area cis product with no trans product detected, the remainder comprised 4.4% area residual starting material and an unknown peak at 11 minutes (10.9% area). LC-MS confirmed the presence of a mass ion for the product at m/z 396. Following heating at reflux, the profile was unchanged and the reaction was worked up. After filtration of Et₃N.HCl, the solvent was concentrated to afford the intermediate phosphodichloridate as an oil. The ¹H NMR was assigned as such, with small amounts of CA4 and Et₃N contaminants. In the absence of a hydrolysis procedure, the crude material was suspended in DCM/water (1:1) and stirred. A white solid was observed to precipitate and, after a period of stirring, was collected by filtration under vacuum. HPLC of this material was predominantly cis product with 4.2% area starting material and several smaller impurities at ca. 1-2% area, a small amount of trans product was detected (99.7:0.3 cis:trans). The ¹H NMR was concordant to cis product with minor amounts of starting material present (apparent doublet at d5.2; FIG. 1).

A second user test conducted in DCM gave a similar reaction profile and ultimately afforded a 38% yield of cis product with a similar impurity profile. Having confirmed the reaction was viable, the product (440 mg) was progressed through stages to make CA4P-mono TRIS:

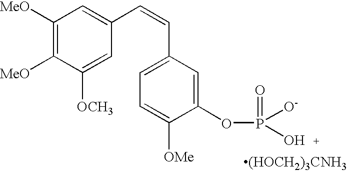

### Control of the Impurities Formed During the Reaction

The main impurities in the POCl₃ reaction (as measured on a chemistry laboratory HPLC) were residual starting material (13.9 minutes, typically 4% area) and peaks at 12.5 minutes and 15.6 minutes. There was also a ‘shoulder’ to the main peak which seemed to alter in intensity between samplings and was attributed to either a dilution effect or incomplete hydrolysis of the phosphodichloridate intermediate.

To address the residual starting material issue a reaction was performed where, after confirmation of incomplete conversion (6.8% area CA4) a further charge of POCl₃ was made. Subsequent HPLC analysis indicated the profile had significantly worsened (12.6% area CA4) and that this was carried through the hydrolytic workup to afford material with 12.2% area residual CA4.

Following the failure to drive the reaction with extra POCl₃, it was decided to increase the amount of triethylamine to stoichiometry with POCl₃ (1.2 equivalents). IPC after 1 hour indicated reaction completion with 0.2% area starting material remaining. The reaction was concentrated to afford the intermediate phosphodichloridate as a clear gel in quantitative recovery (after correction for Et₃N.HCl). This was partitioned between 1M HCl and EtOAc (so that product generated from hydrolysis would dissolve in the organic phase), after drying and concentration, a pale pink oil was obtained. 1M HCl was charged with the intention of re-forming a white solid however, the presence of residual EtOAc meant that a biphase occurred and the mixture had to be re-concentrated. A white solid was eventually formed from a second period of stirring in 1M HCl however, upon filtration and analysis, this material was found to have a 96.4:3.6 cis:trans ratio. In this case it would appear that hydrolysis was not complete prior to the evaporation cycles and that the presence of water/acid the amount of trans isomer increased (as no increase in trans content is evident after the DCM concentration).

Following this, a user test confirmed that starting material could be consumed using the revised amount of Et₃N. IPC after concentration indicated 1.8% peak at 15.6 minutes. Peaks for trans product, starting material or the impurity at 12.5 minutes were no longer visible, with the remaining 98% area comprising 2 peaks (66.6 at 9.3 minutes+31.4% area at 9.6 minutes). The residue was stirred in 1M HCl for 1 hour to afford a mobile slurry. This was filtered and analysed by HPLC in which the double peak was still evident and 2 compounds were clearly visible by ¹H NMR. Presence of product was confirmed by spiking, the other compound was not the phosphodichloridate, but was probably the intermediate between this and product (i.e., monochloro due to partial hydrolysis). (The phosphorylation reactions performed prior to increasing the amount of triethylamine to 1.2 molar equivalents appear to have undergone successful hydrolysis to afford products with the appropriate single peak for cis product.)

The peak at 15.6 minutes was tentatively assigned the dimeric structure depicted below on the basis of a correlating peak in an LC-MS reading.

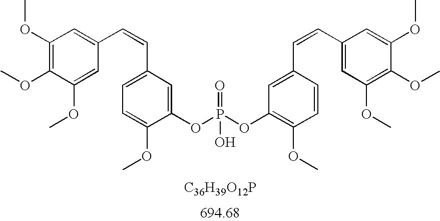

### Assessing Hydrolysis Completion

A sample of material containing peaks at 9.3 minutes and 9.6 minutes (and 15% area trans CA4P) was subjected to several hydrolysis conditions (Table 1). All indicated completion by HPLC after 2 hours stirring.

TABLE 1

| Conditions | Quantity | Result (IPC by HPLC after 2 hours) |
|---|---|---|
| 1M KOH | 10 vol. | Complete hydrolysis |
| | | (no peak at 9.6 minutes) |
| 2% wt Na₂CO₃¹ | 20 vol. | Complete hydrolysis |
| | | (no peak at 9.6 minutes) |
| 1M HCl/acetone² | 10 vol. | Complete hydrolysis |
| | | (no peak at 9.6 minutes) |
| water/acetone | 10 vol. | Complete hydrolysis |
| | | (no peak at 9.6 minutes) |

¹Recommended hydrolysis procedure taken from Bioorg. Med. Chem. Lett., 13 (2003) 1505-1508
²Acetone was charged to form a homogenous mixture for the purposes of sampling, IPA was not used owing to potential for reaction with the phosphodichloridate intermediate

### Hydrolysis in KOH and Isolation of the Free Acid

Hydrolysis in 1M KOH was confirmed after 1 hour 15 minutes and no change in the profile occurred on overnight stirring (Table 2).

TABLE 2

| | Peak (% area) | | | | | |
|---|---|---|---|---|---|---|
| | 8.6 min | 9.3 min | 9.6 min | 13.9 min | | |
| | (trans | (cis | (product | (starting | 14.8 min | 15.6 min |
| Time | product) | product) | unhydrolysed) | material) | (Unknown) | (dimer) |
| 1 h 15 min | 0.2 | 97.5 | ND | 0.1 | ND | 2.0 |
| 17 h | ND | 97.5 | ND | ND | ND | 1.7 |

### Protocol—Phosphorous Oxychloride Reaction

To a stirred solution of POCl₃ (5.3 mL, 58.1 mmol, 1.2 molar equivalents) in dichloromethane (DCM) (153 mL, 10 volumes) at 0 to 5° C. under nitrogen (light excluded) was charged a solution of combretastatin A4 (15.3 g, 48.4 mmol, 1 molar equivalents) and Et₃N (8.1 mL, 58.1 mmol, 1.2 molar equivalents) in DCM over 20 to 30 minutes maintaining the reaction temperature below 10° C. The reaction was stirred at 0 to 5° C. for 50 to 60 minutes and completion was confirmed by ¹H NMR (sample withdrawn and diluted into CDCl₃). The reaction was concentrated in vacuo at=30° C. to afford the intermediate phosphodichloridate as a pale yellow solid. Water (305 mL, 20 volumes) was charged to the residue and the resulting suspension was stirred at 15 to 25° C. for 16 to 20 hours. Completion of hydrolysis was confirmed by HPLC (absence of peak at 9.6 minutes) and the resulting white solid was collected by filtration under suction. The collected solids were washed with water (2×30 mL, 2×2 volumes) and pulled dry under vacuum and nitrogen for 4 hours to afford the required compound as a white solid (19.4 g>100%; 17.8 g, 93% corrected for 4.7% w/w water by KF and 92% w/w by ¹H NMR).

### Protocol—Optimized Phosphorous Oxychloride Reaction

To a stirred solution of POCl₃ (29.11 g, 0.047 moles, 1.5 molar equivalents) in tetrahydrofuran (THF) (400 ml, 10 volumes) at −35 to −45° C. was added a solution of combrestatin A4 (40 g, 0.031 moles, 1 molar equivalents) in 200 mL of THF over a period of 2-3 hours. The reaction was maintained at −35 to −45° C. for another 1-2 hours, and completion of the reaction was confirmed by HPLC. The reaction temperature was raised to 0-5° C., quenched with water followed by azeotropic removal of THF. The aqueous solution was cooled to 15-20° C., and stirred for another 24-26 hours. The product was isolated by filtration and dried at 55-60° C. for 10-12 hours to yield the product as a white solid (46.7 g, 93.1% yield) with HPLC purity of 98.66%.

### Protocol—Preparation of CA4P-TRIS:

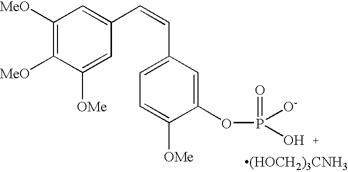

To the IPA solution of the cis form of the corresponding phosphoric acid (11.7 g, 1 wt., corrected for IPA only) was added IPA (to a total of 102.3 mL, 6.91 wt.-eq. to 8.8 volumes). The solution was filtered through GF/F paper and the filtrate charged to a 3 necked round bottom flask equipped with a mechanical stirrer and dropping funnel. IPA (11.7 mL, 1.0 volumes) was used as a line rinse (previously filtered through the filtration equipment used for the filtration of the cis CA4P solution).

TRIS (3.63 g, 0.31 wt, 1 eq) was charged to a separate 250 mL round bottom flask equipped with a magnetic stirrer. Water (102.3 mL, 8.8 volumes) was charged to the flask at 16° C. to 25° C. and the reaction mixture was stirred for at least 15 minutes until complete dissolution was achieved. The aqueous solution of TRIS was filtered through glass fibre filter paper and the filtrate was then added to the solution described above over 45 minutes with rapid stirring. Water (11.7 mL, 1.0 volumes) was used as a line rinse (previously filtered through the filtration equipment used for the filtration of the TRIS solution). The resulting off-white suspension was stirred at 16 to 25° C. for 1 hour during which time crystallisation was noted. A further portion of filtered IPA (234 mL, 20 volumes) was added over 15 minutes. The off white suspension was aged at 16° C. to 25° C. for 2 hours 15 minutes before being filtered under suction. The filter-cake was washed with filtered IPA (114.7 mL, 9.8 volumes), pulled dry on the filter for at least 1 hour and then further dried at 75° C. to 80° C. under vacuum for 16 hours. Crude product was obtained as a pale yellow solid (12.1 g, 105% w/w, 79%: Yield based on the input value corrected for IPA only.) [111 to 128% w/w or 85% to 98% was the expected range]. The IPA content was less than 1% w/w by ¹H NMR (D₂O).

### Protocol—Upgrade of CA4P-TRIS:

The TRIS salt (11.3 g, 21.8 mmol), IPA (113 mL, 10 volumes) and H₂O (113 mL, 10 volumes) were charged to a 250 mL round bottom flask equipped with a mechanical stirrer, thermometer, nitrogen input and bubbler. The heterogeneous reaction mixture was heated to 38 to 42° C. for 1.5 hours. The reaction was cooled to 16 to 22° C. and stirred at this temperature for 1.5 hours. The solid material was isolated by filtration under suction and the filter cake washed with IPA (56.5 mL, 5 volumes). The solid was pulled dry on the filter paper under suction for 1 hour and then further dried in a vacuum oven at 75 to 80° C. This afforded a white solid (10.1 g, 89%) [75 to 100% expected range]. ¹H NMR (D₂O) was consistent with the required structure.

What is claimed is:

1. A method of synthesizing a phosphoric acid of combretastatin A-4, combretastatin A-4 derivatives, and trans-isomers thereof comprising:
reacting a combretastatin A-4 or a combretastatin A-4 derivative having the following chemical structure: 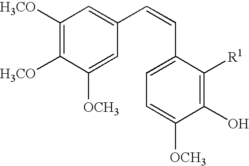
wherein R¹ is H or OH,
with POCl₃ and a base in the presence of a solvent to form said phosphoric acid of combretastatin A-4 or combretastatin A-4 derivative.

2. The method of claim 1, wherein the base is an amine.

3. The method of claim 2, wherein the amine is Et₃N.

4. The method of claim 1, wherein the solvent is a halogenated solvent.

5. The method of claim 4, wherein the solvent is DCM.

6. The method of claim 1, wherein the solvent is an ether.

7. The method of claim 6, wherein the solvent is THF.

8. The method of claim 1, wherein the intermediate phosphodichloridate is hydrolyzed to form said phosphoric acid of combretastatin A-4 or combretastatin A-4 derivative.

9. The method of claim 8, wherein the intermediate phosphodichloridate is hydrolyzed with water, acetone, KOH, Na₂CO₃, ethyl acetate, or any combination thereof.

10. The method of claim 1, wherein POCl₃ is first added to the solvent of the reaction, followed by addition of the base and combretastatin A-4 or a combretastatin A-4 derivative.

11. The method of claim 1, wherein the reaction components are added to the reaction mixture at temperatures between 0-25° C.

12. The method of claim 1, wherein the reaction components are added to the reaction mixture at temperatures between 0-5° C.

13. The method of claim 1, wherein the reaction components are added to the reaction mixture at temperatures between −3 to −45° C.

14. The method of any one of the above claims, wherein R¹ is H.

15. The method of any one of the above claims, wherein R¹ is OH.

16. A method of synthesizing a compound of the following formula: 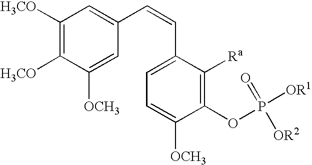
wherein R^{a} is H or OP(O)(OR³)OR⁴; and
OR¹, OR², OR³ and OR⁴ are each, independently, OH or —O⁻QH⁺ or —O⁻M⁺, wherein M⁺ is a monovalent or divalent metal cation, and Q is, independently:
a) an amino acid containing at least two nitrogen atoms where one of the nitrogen atoms, together with a proton, forms a quaternary ammonium cation QH⁺; or
b) an organic amine containing at least one nitrogen atom which, together with a proton, forms a quaternary ammonium cation, QH⁺;
comprising
reacting a combretastatin A-4 or a combretastatin A-4 derivative having the following chemical structure: 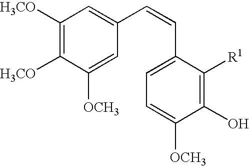
wherein R¹ is H or OH,
with POCl₃ and a base in the presence of a solvent to form said a phosphoric acid of combretastatin A-4 or combretastatin A-4 derivative; and, optionally,
reacting the phosphoric acid with an appropriate amine or metal cation to form said pharmaceutically acceptable salt of combretastatin A-4 or combretastatin A-4 derivative.

17. The method of claim 16, wherein the salt of combretastatin A-4 or combretastatin A-4 derivative is subsequently upgraded with water, acid, IPA, or any combination thereof.

18. The method of claim 16, wherein the amine is TRIS, histidine, ethanolamine, diethanolamine, ethylenediamine, diethylamine, triethanolamine, glucamine, N-methylglucamine, ethylenediamine, 2-(4-imidazolyl)-ethylamine, choline, or hydrabamine.

19. The method of claim 18, wherein the amine is TRIS.

20. The method of claim 18, wherein the metal cation is Li, K, Na, Cs, Mg, Mn, Zn or Ca.

21. The method of claim 16, wherein R^{a} is H.

22. The method of claim 16, wherein R^{a} is OH.
